(19) United States
(12) Patent Application Publication
(10) Pub. No.: US 2003/0004897 A1
(43) Pub. Date: Jan. 2, 2003

(54) Method and system for communicating user specific information

(76) Inventor: James E. Smith IV, Redwood City, CA (US)

Correspondence Address: Jurgen K. Vollrath, 1222 Settle Ave., San Jose, CA, 95125, US

(21) Appl. No.: 10/044,579

(22) Filed: Oct. 23, 2001

Related U.S. Application Data
(63) Continuation-in-part of application No. 09/894,613, filed on Jun. 27, 2001.

(51) Int. Cl. H04K 1/00; H04L 9/00; G06F 17/60

(52) U.S. Cl. 705/76

(57) ABSTRACT

In dealing with electronic communications and electronic transactions and data transfer, a system and method provides for greater security and ease of use by making the communication user specific and placing the user in control of the disclosure of information about him/herself. This allows for secure transfers, targeted marketing, and provides greater ease in accessing the internet and performing transactions over the internet. For instance, the ability to identify a user allows a credit card provider to dynamically generate confirmation codes for use in credit card transactions. Both parties can also use the gathered information to perform appropriate background checks on the other. The personalizing information can be stored on a portable device, thereby allowing the user to upload the information to any machine and personalize it. Such a portable device can include a variety of information including code for automatically transferring relevant user information to user information request forms on intenet sites. It can also include internet browser assisting code for translating simple intuitive descriptors into one or more internet addresses thereby allowing the internet to be browsed by simply typing in the descriptors instead of internet addresses.

This is a Continuation-in-part application of 09/894,613 and is owned by the same inventive entity.

### FIELD OF THE INVENTION

The invention relates to a method and system for communicating digital content. In particular it relates to simplified and more secure transfer of digital information.

### BACKGROUND OF THE INVENTION

With the information age, the need for distributing information effectively is becoming increasingly important. Not only is the appetite for rapid content delivery increasing from day to day, but peoples' expectations regarding the manner in which content is being presented, and the types of content that are available are becoming ever more diverse. Thus there is a simultaneous need to simplify the user interaction, improve the user experience, and address security issues.

One of the issues raised by digital content delivery and on-line transactions is the challenge regarding the protection of users on the Internet and protection of content against unwanted intrusion. Due to the speed and flexibility of the medium, digital content delivery is a prime target for illegal and unethical activity. One aspect of the protection problem involves the content itself. Digital content is at risk of being intercepted by unauthorized persons. This creates a concern, not only in day to day communications, but more specifically in on-line transactions in which credit card information is sent over networks such as the internet.

However security and protection of content are not the only issues. The ease of use of the internet, and the avoidance of having to provide duplicative information in on-line transactions needs to be addressed. There is a need to simplify the filling out of internet forms in conducting on-line transactions. Also, there is a need to simplify browsing and other functions. A user wishing to access a particular web site, currently has to be familiar with the exact web address in order to locate the site. Alternatively, the user has to first invoke one or more search engines, type in descriptive information, and then sift through the hits that are returned, in order to locate a site of interest. What is needed is a simple, intuitive way of locating one or more relevant web sites.

Furthermore, there is a need for providing a facility to allow a user to carry his personal information, including personal identifying information, around with him or her. In this way, no matter what machine a user uses, his or her personal information is linked to the communications, thereby making the communications user specific and allowing the user to automatically set up the machine to his or her preferences.

The present invention seeks to address these issues of user and content protection, and simplifying on-line communications.

### SUMMARY OF THE INVENTION

The invention deals with user specific communications through the use of a protocol that allows the user to be uniquely identified and subsequent communications to be structured according to the user information. This user information may be any information that identifies the user, and may includes, among other things, demographic and preference information. The structuring of the communications may also take into account user machine capabilities. This structuring of information to the specific user facilitates the simplification of electronic communications and transactions, and allows various advantages to be realized. It makes possible the transmission of digital information from content providers to consumers and vice versa, in a way that meets the needs of the sender and the recipient. Greater security can be achieved in credit card transactions, and internet access can be simplified by facilitating auto form filling capabilities, and by providing for the use of simplified descriptive terms instead of web addresses to access defined web pages. It allows for targeted marketing, since the recipient of the communication is known. The invention further contemplates the provision of a portable memory device that contains user information, including user identifying information, as well as other features to simplify internet communications. Thus it may include code for automatically filling out internet forms, and code for simplifying internet browsing.

According to the invention, there is provided a means for supplying user information from a user information source to a form or table on a computer, having user information fields, comprising code for enabling the computer to consume enabled content, wherein the user information is in the form of enabled content, and code for transferring at least some of the user information from the user information source to the form or table. The form may be a form on a web page, and the user information source may be a portable device and include the code for enabling the computer. The computer is typically a machine capable of browsing the internet. The user information source typically includes a user interface that defines a template with fields for receiving user information and wherein at least some of the user information corresponds to at least some of the user information fields in the form. The means for supplying user information to a form or table, typically also includes code for requesting and verifying a password to transfer the user information. The password is typically a word, phrase, or other assembly of one or more of numbers, letters, and symbols. One of the features of the invention is to simplify surfing of web pages.

Further, according to the invention, there is provided a means for supplying user information from a first device to a second device by means of a communications protocol, comprising code for enabling the first device to consume enabled content according to the protocol, wherein the user information is in the form of enabled content, and code for transferring at least some of the user information to the second device.

Further, according to the invention, there is provided a method of supplying user information to a form or table having user information fields, comprising gathering at least part of the information required by the fields, storing said gathered information in a local or portable storage device, and extracting said gathered information from the storage device and inserting it into the form or table. The information in the storage device may be used to fill out any forms, such as internet forms, that require some or all of the stored information.

Still further, according to the invention, there is provided a method of simplifying internet browsing, comprising providing software code for associating a descriptor with one or more internet addresses, and providing software code for accessing the internet site or the choice of internet sites in response to entry of the descriptor. The descriptor may be entered by typing it into an internet address field of a browser interface, and typically takes the form of a word, phrase, or other assembly of numbers, letters, and symbols.

Still further, according to the invention, there is provided a method of simplifying access to internet sites, comprising providing a browser interface that eliminates the need to type in web addresses by providing a facility to configure the browser to associate one or more internet sites with a predefined descriptor. The user accesses sites by typing in predefined descriptors or by selecting from one or more lists of available sites. The descriptors may be words or phrases or any other combination of letters and numbers.

Still further, according to the invention, there is provided a portable user device, comprising a memory with user specific information, and software code for facilitating the transfer of at least part of the user specific information to a third party request form on a computer, wherein the user specific information includes information required for credit card transactions. The memory typically also includes code for enabling the computer to consume enabled information, wherein the user specific information is provided as enabled information that can only be consumed by an enabled machine. The memory typically also includes code for requesting user verification for the transfer of any of the user specific information. The third party request form is typically part of an on-line transaction form. The device may, further, comprise software code that associates at least one internet address with a predefined descriptor, such as a word, phrase, or other assembly of one or more numbers, letters, and symbols. The associating code may interact with network browser software to download an internet page or provide a choice of internet pages associated with the descriptor, when the descriptor is selected or typed in on a user interface associated with the browser. The user specific information may include medical information about the user, and may include consent information to perform one or more medical procedures. The user verification information may include a plurality of passwords, each of which facilitates access to one or more predefined portions of the user specific information. At least one of the passwords may be of a generic nature that is commonly known to facilitate access to the corresponding one or more portions by anyone entering the password. The invention contemplates replacing all existing access cards with a single intelligent card of the invention. Thus, the user specific information may include one or more of credit card information, debit card information, ATM card information, office access card information, club access card information, medical information, gas station card information, toll gate pass information, and internet site subscription information. Ideally the device is shaped substantially like a credit card, or has means for securing the device to a person or to belongings commonly carried by people, such as a key ring, hand bag, school bag, or backpack.

Still further, according to the invention, there is provided a portable user device comprising software code that associates at least one internet address with each of a plurality of predefined descriptors, and software code for interacting with network browser software to download an internet page or provide a choice of internet pages associated with a descriptor, when said descriptor is selected or typed in on a user interface associated with the browser.

Still further, according to the invention, there is provided a method of providing greater security to a credit card transaction, comprising associating a user identifier with a user or a user's credit card number, wherein the user identifier dynamically changes at defined intervals or occasions.

Still further, according to the invention, there is provided a method of performing a credit card transaction between a credit card holder and a seller, comprising, submitting a confirmation code to the seller, wherein the confirmation code is changed automatically at defined intervals or defined occasions. The confirmation code may be changed automatically before or after each transaction, and may be generated by the credit card issuer or an authorized third party acting on behalf of the credit card issuer. The confirmation code may have a predetermined validity period or life span. Preferably, the confirmation codes are sent to the credit card holder electronically over an electronic network. In addition, credit card information may be submitted to the seller, wherein the credit card information and confirmation code may be submitted to the seller over an electronic network, and the credit card issuer or authorized third party may process the credit card transaction and generate a new confirmation code which is sent to the credit card holder over the network. Preferably, the confirmation code is linked to user identifying information, and stored in memory that is accessible to the credit card issuer or authorized third party.

Still further, according to the invention, there is provided a method of checking a party's identity in a transaction, comprising requesting user information from the party, and submitting the user information to a third party or software program. The software program typically compares the user information to a database of information and identifies problems. If a problem is identified, the method may include notifying one or more predefined third parties. For example, the transaction may be a request for a plane ticket or a ticket to an event, and is typically part of an on-line transaction.

### BRIEF DESCRIPTION OF THE DRAWINGS

FIG. 1 is a representation of a general client-server arrangement;

FIG. 2 shows one embodiment of a browser user interface of the invention;

FIG. 3 shows one embodiment of a user identification method of the invention;

FIG. 4 shows one embodiment of a secondary screen invoked by clicking on one of the options of the browser user interface of FIG. 2;

FIG. 5 shows one embodiment of another secondary screen invoked by clicking on one of the options of the browser user interface of FIG. 2;

FIG. 6 shows another embodiment of a browser user interface of the invention;

FIG. 7 shows the effect of clicking a drop down menu on the browser user interface of FIG. 6;

FIG. 8 shows the effect of entering a search term in a search term window on the browser user interface of FIG. 6;

FIG. 9 shows one pop-up window invoked by selecting a Settings option on the browser user interface of FIG. 6;

FIG. 10 shows another pop-up window invoked under the Settings option on the browser user interface of FIG. 6 by selecting a Kid's Protocol subcategory;

FIG. 11 shows yet another pop-up window invoked under the Settings option on the browser user interface of FIG. 6 by selecting a Schedule subcategory;

FIG. 12 shows yet another pop-up window invoked under the Settings option on the browser user interface of FIG. 6 by selecting the Add Family Member tab;

FIG. 13 is a flow chart showing one example of enabling an intelligent device;

FIG. 14 is a flow chart defining the steps involved in providing enabled content;

FIG. 15 shows an embodiment of a user interface for selecting internet sites using predefined terms, and

FIG. 16 shows an embodiment of a user interface for entering user information and mapping the user information to terms commonly found on internet form.

### DETAILED DESCRIPTION OF THE INVENTION

The present invention deals with a method and system for making communications user specific by associating user information with the communications. As is discussed in greater detail below, this is achieved by making use of a communication protocol which allows the user to decide how much information he/she is willing to disclose during any communication session whether that be an on-line transaction, request for information, or any other communication. User information includes information to uniquely identify a user. This can include different types of information such as date of birth, biometric information, e.g, retinal scans, finger prints, voice prints, etc., credit card information, mothers maiden name, and other characteristic information, including preference information that helps to identify the user, e.g., the user's favorite color, the user's favorite sport, the user's favorite music, etc. These all contribute to building a unique user identity. It will be appreciated that not all of this information will always be required in a communication. Different communications may require different information to uniquely identify a user. Furthermore, the user can decide what information he/she is willing to submit. Also, the system is flexible enough to direct communications to a unique user group, e.g., all male users between the ages of 18 and 35 years who like football and are vegetarians.

This ability to communicate using a protocol that verifies user identity, allows a number of benefits to be realized, including simplified internet browsing and auto form filling, as well as facilitating more secure credit card transactions. By providing digital content in a manner that is peculiar to the recipient, it is possible to take into account both the interests of the information recipient and the information provider. This allows the interests of the participants to be protected. In addition to the security feature, it allows the user or recipient of digital goods, digital information, or other digital content to receive information according to his/her preferences. The protocol can also gather information about the user's machine capabilites and, thereby providing information in accordance with the user's electronically controlled environment. The invention thus finds numerous applications, some of which will be discussed in greater detail below.

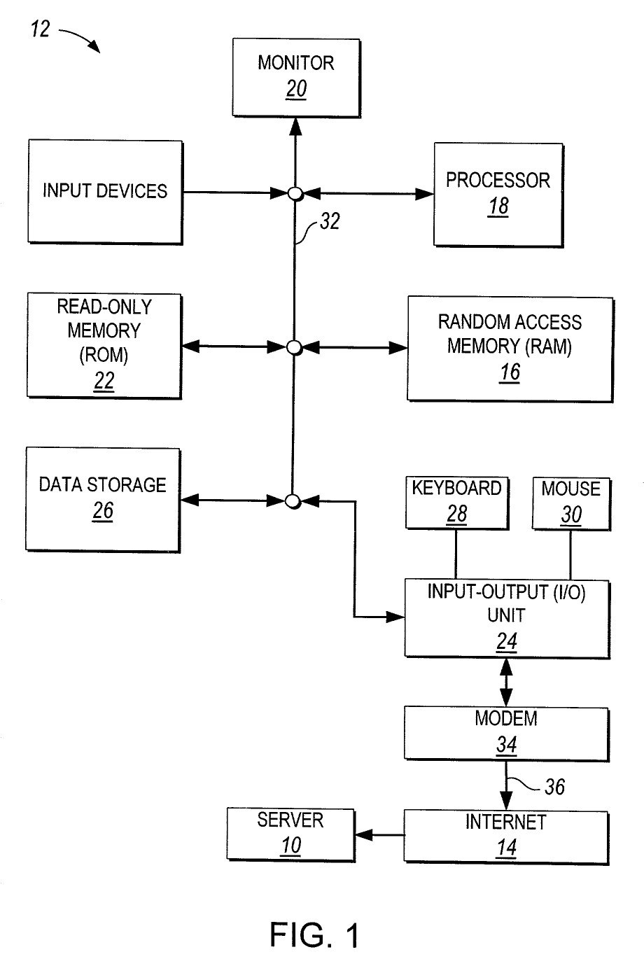

In order to illustrate the underlying concepts of the invention, which involve the use of a communication protocol that introduces the concept of enabled content and enabled communicating devices, one embodiment of the invention, involving a simple client-server environment, will be considered. FIG. 1 shows a server machine 10 connected to a client machine 12 through a network 14 such as the internet. The client machine 12 includes a Random Access Memory (RAM) 16 into which the software program for implementing the functionality of the invention is loaded, a processor 18 for executing the program, a visual display unit or monitor 20 for providing a visual display of information, a Read Only Memory (ROM) 22 for storing firmware, an input-output (I/O) unit 24 for connection to a printer, modem, etc., and a mass data storage 26 which can be one or more suitable storage devices such as a hard magnetic disk drive, a removable (floppy) disk drive, and optical (CD-ROM) drive, etc. The program which implements the invention may be stored in the storage 26, and modules of the program loaded into the RAM 16 for execution as required. User access to the machine 12 is provided by input units comprising an alphanumeric keyboard 28 and a pointing device such as a mouse 30. The elements of the machine 12 are interconnected by a bus 32.

While the client machine 12 of this embodiment is depicted as a PC, it will be appreciated that this is just one embodiment of a client machine 12. The client machine 12 could equally well take the form of a lap-top or palm-top machine or an information appliance geared for accessing the Web. As shown in FIG. 1, the client machine 12 is connected to the server 10 via a modem 34 and telephone line 36 forming part of a network 14, in this case the Internet. It will be appreciated that the machines 10, 12 can be connected by any network arrangement, which can include any combination of: coaxial cable connections, optical fiber connections or even wireless connections, such as Bluetooth.

As will become clearer from the discussion below, this is only one embodiment of the invention. The application of the invention is, however, broad enough to cover not only client-server or other networked arrangements but also peer-to-peer communications, standalone systems, and, in fact, any intelligent device that can be enabled with enabling code in accordance with the invention. As is discussed in greater detail below, the invention includes enabling any intelligent appliance which is designed to communicate information. The former may be a standalone or networked PC with capabilities for playing a CD-ROM. The latter may be a smart card or key ring device carrying personalized information, to facilitate personalizing a user's environment such as his or her office, motor vehicle, personal computer, etc. This is achieved by transferring the information in the device to a controller that controls the user's environment.

Considering again the client-server arrangement of FIG. 1, the computer software program, also referred to as the machine enabling software or the machine enabling code, which implements the functionality of the present invention on the user's machine, can be loaded onto the client 12. This can be achieved by any one of a number of methods. In this embodiment, the program is supplied on an optical CD-ROM disk. It is loaded into the client machine 12 and stored on the hard drive 26 by running a setup program. It is, however, within the scope of the invention to provide the program, which, for convenience will be referred to as System X, on any other computer readable medium. For instance, it can be supplied on one or more magnetic elements such as floppy disks, or stored in a ROM or other computer memory element. It can be provided on a portable memory device, e.g., a disk or other storage medium on a keyring where information is transferred via a physical connector or wireless means, e.g., Bluetooth. It could also be retained on the server machine 10 or on one or more other storage devices external to the client 12 and server 10, and supplied to the client 12 over the network 14, for example as an Active X component or Java Applet. The enabled device, in this case the client 12, communicates with another device or content, which, insofar as the other device or content is enabled, will interact with the client to provide content according to parameters defined by the enabled content or the other device.

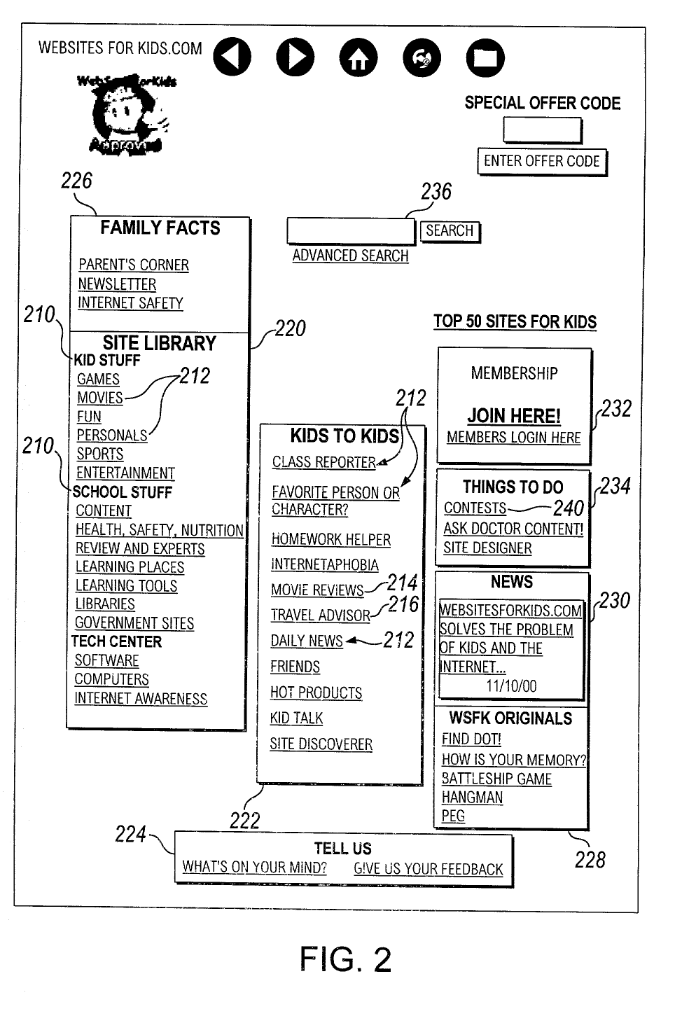

The functionality of the present invention will be described first, with reference to FIGS. 2 to 8. Thereafter, the installation and the internal structure and operation of the software will be discussed in detail.

Functionality

In the case of certain user groups, such as children, it may be in the interest of the user or someone acting for the user, for example, a child's parent or legal guardian, that the user only have access to certain pre-approved or supported web sites or material. This is one implementation of the invention in which communications with the user are structured to the user's unique identity. As part of the enablement of the device, in this case the client computer, information is requested from the user's guardian, that will allow the user to be identified. Thus, the enabled device will include an implementation of a communications protocol and information identifying a particular user, since one of the important features of the protocol is the ability to exchange information and adjust the content that is consumable, based on such information. Thus it acts as a broker for communicating between two devices or processes. For example, demographic information can be provided by a consumer, or delivery preferences, personal preferences, content preferences, or financial information, to name but a few.

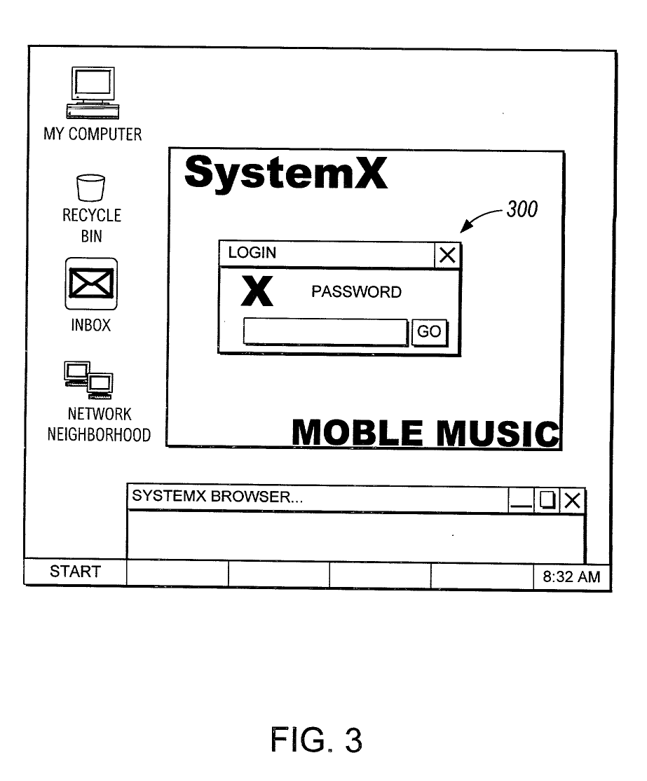

Once the user device has been enabled, it will, prior to a communication session, request that the user verify his or her identity. This is over and above the user specific information that is gathered about the user and used for user specific communications. The user verification serves merely to avoid someone else assuming a particular user's identity. This verification may take different levels of identity or authentication, e.g., simple user identification by means of a password, credit card information with or without additional verifying information, third party verification, where the third party acts as intermediary, biometric verification such as finger prints or retinal scans, voice proofs, etc. Thus, in one embodiment, the user identification simply takes the form of a password as depicted by the request box 300 in FIG. 3.

In the present embodiment the child user is specifically precluded from accessing undesired internet sites by providing a browser with a user interface such as the one depicted in FIG. 2, which shows a network browsing screen of a browser user interface. The browsing screen specifically does not include a web address entry location. Instead, a user is restricted in his/her choices by being limited to selecting from pre-defined categories 210, which, in turn, may each provide further sub-choices 212 from a list of supported sites. In this embodiment, the browser includes drop down menus or other selection facilities to limit a child's access to only pre-approved sites. Clearly such a browsing screen, which avoids the need to type in web addresses, would be useful in other applications as well, especially in small web access appliances having limited or laborious user access functionality such as touch sensitive screens relying on character recognition software.

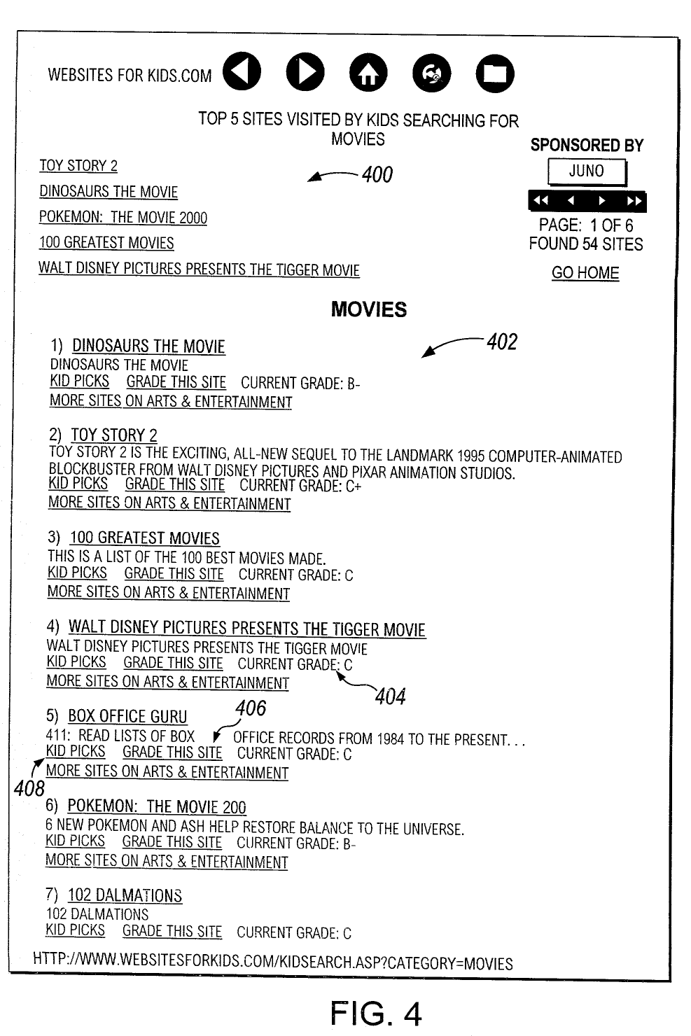

Referring again to FIG. 2, some of the features provided by this embodiment, are discussed. The user may, for example, select Movie Reviews 214 from the sub-categories 212, by clicking on Movie Reviews 214. This brings up a list of movie sites 400 (FIG. 4) most commonly visited by kids and the most popular movies 402 for the user's age group. It also provides kids with the facility to view the grade value associated with a movie (Current Grade button 404) and to Grade the site themselves (button 406). It also allows other sites which were accessed by kids in that age group, to be accessed (Kids Pick 408).

From the layout of the search page (FIG. 2) which is also the home page in this embodiment, it will be noted that the search categories in this embodiment have been grouped to distinguish between information supplied by content providers 220, interactive information 222 as provided by the kids amongst themselves, feedback information 224 provided to content and service providers, legal and parental information 226, games 228, information about the site 230, a log in site 232 to verify the identity of the particular user, miscellaneous areas of interest 234, and a search term entry field 236 linked to a search engine.

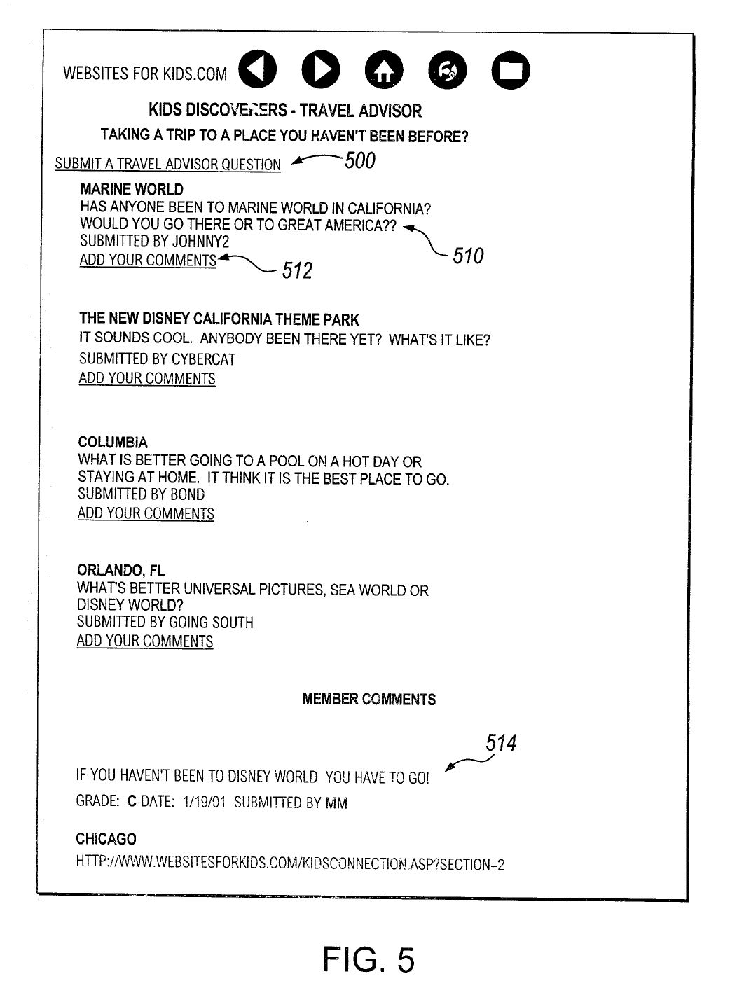

FIG. 5 shows a sub-page, which was accessed by clicking on Travel Advisor 216 (FIG. 2). It includes a hyperlink 500 that brings up a page (not shown) with data entry fields allowing users to submit requests for information feedback on travel sites. These requests are posted on the Travel Advisor page (FIG. 5) as shown. For example, the information request 510 submitted by a kid with the user name Johnny 2, seeks information on Marine World. Responses can be submitted by clicking on the Add your comments link 512. The responses 514 are posted at the bottom of the page.

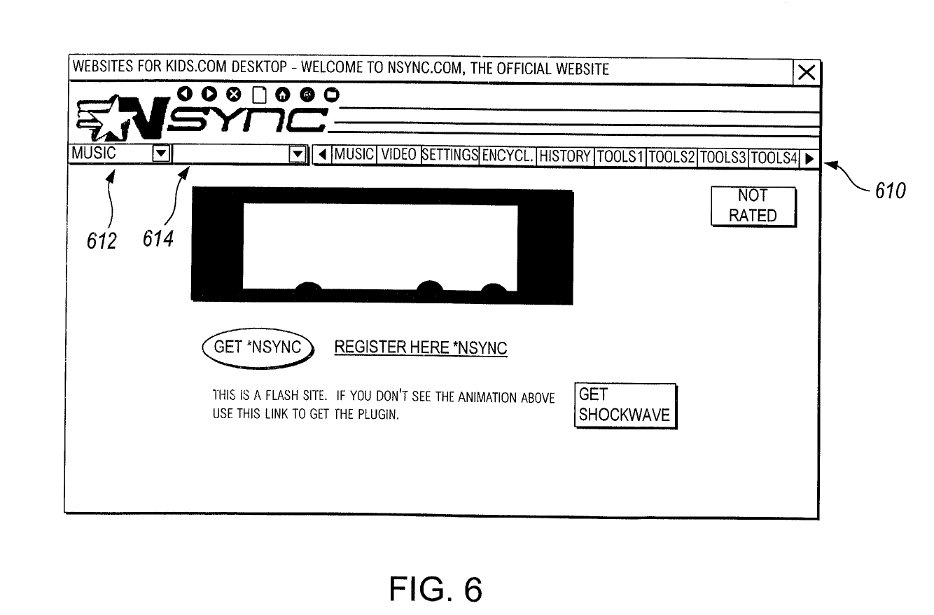

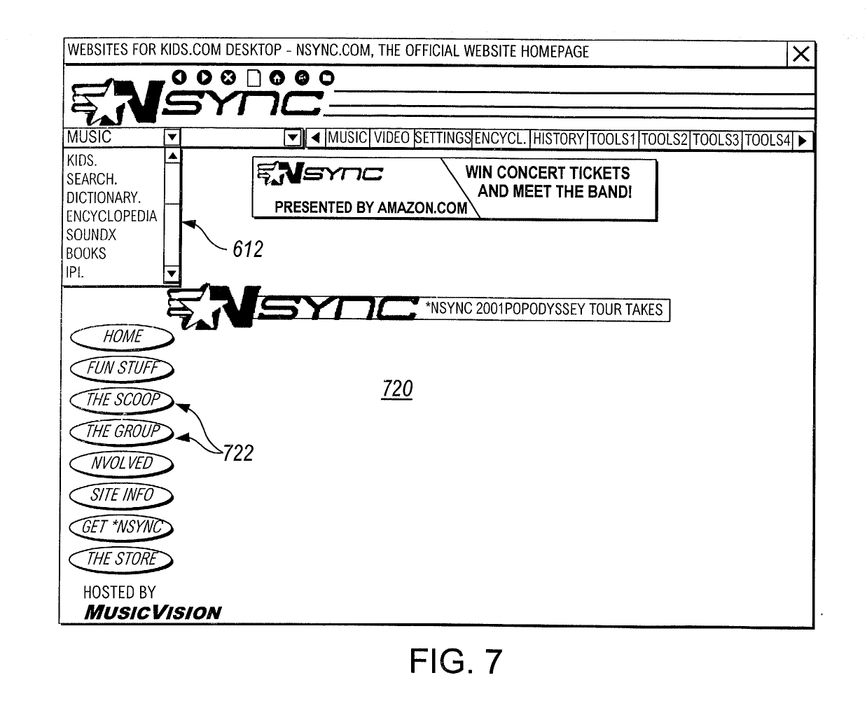

It will be appreciated that the layout and type of information presented in FIGS. 2-5 are examples of one embodiment only. Different categories and layouts could equally well be implemented. Computers could also be enabled for specific types of information or applications. The invention also envisages using the browser user interface page as an advertising medium. For instance, a particular entity may license the rights to distribute the browser, and may make the browser available with its logo or other features on the browser home page. For example, FIG. 6 shows a NSYNC browser page with NSYNC's logo and search categories 610. It also includes a drop down menu 612 and search term entry field 614. The drop down menu 612 is shown in FIG. 7 which also shows a subsequent page 720 in the lower portion of the display, with additional hyperlink subcategories 722.

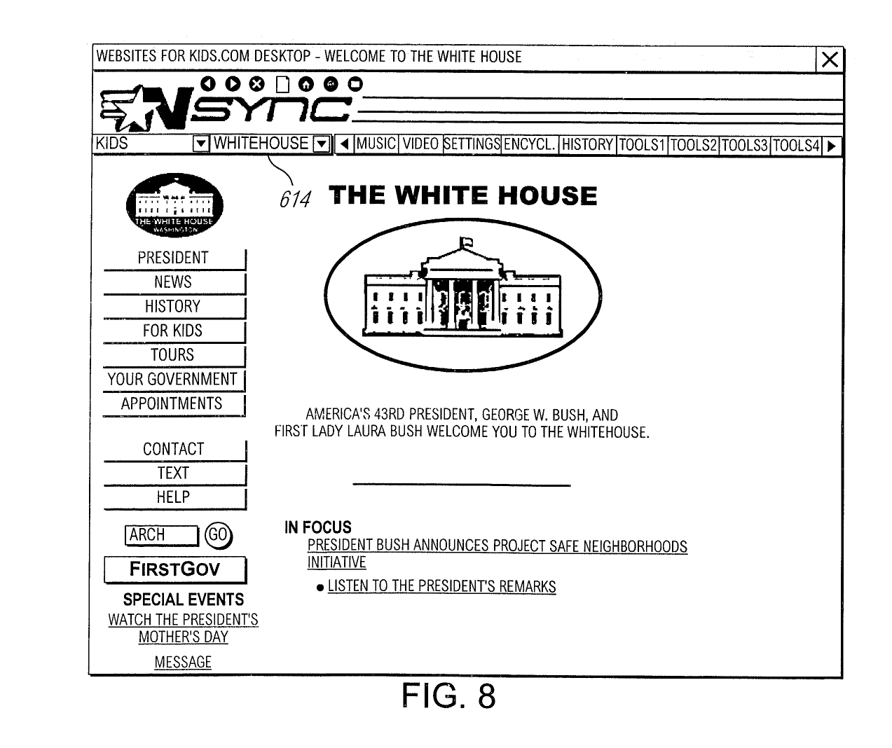

FIG. 8, in turn, shows the result of entering the term “whitehouse” in the search term entry field 614. Again, only approved sites are made available according to the negotiations performed by the protocol, taking into account the user information that was originally gathered.

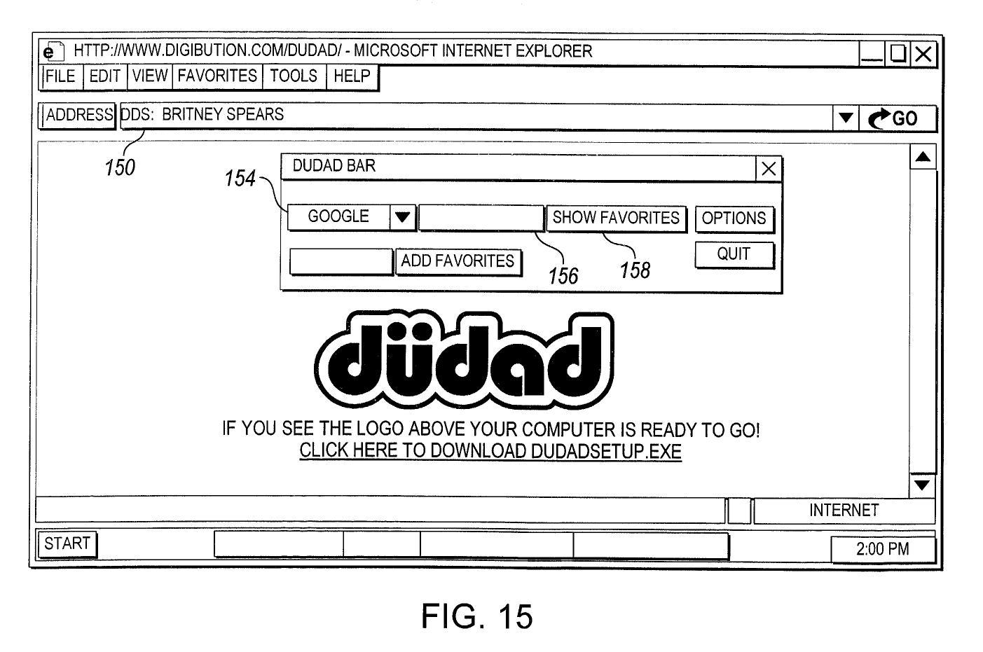

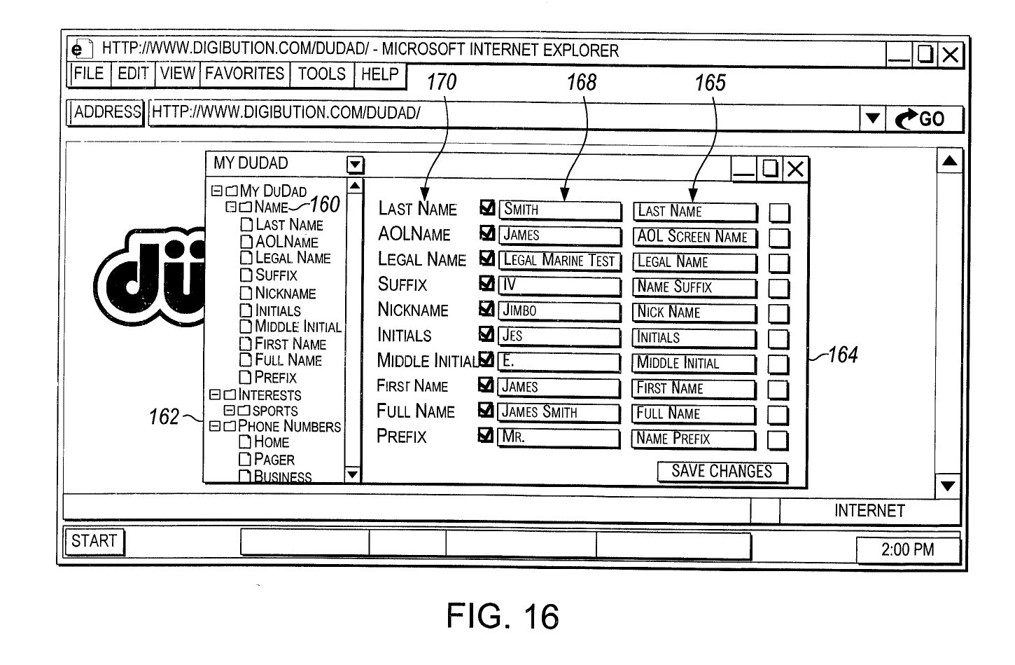

While the embodiment discussed above and illustrated in FIG. 8 deals with a browser user interface that specifically prevents the typing in of internet addresses, the invention can also be implemented in an embodiment that uses a standard browser user interface. While such an interface will not prevent a user from accessing undesirable sites, this embodiment, nevertheless simplifies the browsing process. By including code for associating intuitive descriptors or terms in the form of words or phrases or other search terms, including combinations of numbers, letters and symbols, with one or more internet sites, the user is given the ability to avoid having to memorize web addresses. In effect, this feature provides an alternative DNS by providing a domain naming feature. In one embodiment a user interface is provided to allow either a supplier, or, in other embodiments, a user, to define terms and map them to one or more internet addresses. Thereafter, typing or selecting a predefined term will automatically download the corresponding internet site, or, in the case of more than one site, will list the sites from which the user can then select the desired site. FIG. 15 shows a user interface in which the user can type in the predefined term in the Address entry field 150, in this case “kids: britney spears” which was previously mapped to Britney Spear's web site. It will be noted that this avoids the need for typing in www or adding .com. Also, britney spears is spelled intuitively as two words, thereby avoiding the need to remember whether the two words should be written together, hyphenated, or joined by a dot or underscore. Instead of typing in the term in the Address field 150, the user, in this embodiment can, instead, bring up a search box 152, which has a folder field 154 and an address name field or file field 156. In this embodiment the field 184 includes a drop down box to show the predefined folders. In this case “Google” is shown, however, it would also include a “kids” folder which would allow the address shown in the Address field 150 to be emulated. The address name field 156, in this example is blank. However, a user could enter “britney spears” in conjunction with the folder designation “kids” to download the Britney Spears site, as before. Instead of typing in the address name, the “Show Favorites” box 158 could be selected to show all the favorite predefined address names. The mapping of the folders and address names to the internet sites can be achieved in a number of ways, for example, using shortcuts. One such approach is described in more detail below with reference to FIG. 16, regarding the mapping of personal information to typical web page tables.

It will therefore be appreciated that this feature of the invention allows a user simply to type an intuitive word or phrase into the internet address location of a browser user interface, or to select it using a separate box. This word or phrase is then associated with one or more internet addresses. Insofar as there is only one corresponding internet address, e.g., one web page, this will automatically be invoked and downloaded for the user. If there is more than one corresponding internet address that has been associated with the word or phrase, the user, in one embodiment, will be presented with a list of internet sites to choose from by listing the addresses in the form of hyperlinks that the user can then select by clicking on the desired link. In one embodiment, the user is given the ability to define his/her own words or phrases and linking internet addresses to the words/phrases as they see fit. In another embodiment, the words/phrases are predefined, as are the associated internet addresses. Such an embodiment has the advantage of providing a marketing tool by automatically exposing the user to certain predefined sites whenever the user enters the corresponding intuitive word or phrase. For example, a user wanting to obtain information on growing irises may enter the phrase “iris growing” or “growing irises” or simply the word “irises” or “gardening”. Each of these options may be predefined and linked to one or more internet sites, e.g., Web sites. Web site owners can thus get exposure and will be willing to pay an advertising charge corresponding to the prominence or location of their web address in the list of returned sites. They could even get exclusive coverage by paying for the benefit of having only their site linked to the search term or phrase and preferably having their Web page downloaded automatically. The help of Web site owners could be invoked in deriving appropriate words or phrases for the corresponding Web sites. The invention, however, is flexible enough to encompass different embodiments. For instance, it contemplates either the user defining the terms that are associated with the internet addresses, or having the terms predefined or defined in response to information gathered about the user. In one embodiment the user is permitted to change the terms, while another embodiment specifically prevents this. As mentioned above, by predefining the terms and websites associated with the terms, the invention provides a way for marketing certain websites by defining the order in which the sites are presented to the user in response to the entry of a term. For example, the term “pizza” may be associated with “Pizza Hut” as the first website, “Pizza Lover” as the second website, “St. John's Pizza” as the third website, etc. In this way the invention can be used as a business tool to generate revenue based on advertising. Since the protocol of the present invention allows targeted communications, different geographic areas or different user groups may have different web addressess associated with a term. For example, if a term “food” or “restaurant” is entered, a web site for “Chucky Cheese” may be presented in the case of a child user, whereas an adult above the age of 28 years may be presented with a local French Resaurant that seeks to target adults above the age of 28 years. Similarly, geographical considerations may be taken into account in defining the order of preference by which sites are presented in response to a search term. For example, in an area where “Willow Street Wood Fired Pizza” is available, this may be the first choice presented to a user living in that area, when “Pizza” is typed in as a term.

In the embodiment where the user can define or redefine websites and terms associated with websites, it may, in some situations, be desirable to associated non-intuitive identifiers with one or more internet addresses insofar as a peer-to-peer communication wishes to establish a communication channel that is not otherwise accessible to anyone else.

It will be appreciated that the addresses linked to the terms need not be internet addresses but could be any file addresses. As mentioned above, the association of websites with certain terms can be done in a variety of ways. For instance, one common method to equate a term with an internet site or memory location is through the use of a shortcut.

Another feature of the invention is the ability to automatically fill out internet forms downloaded from a server computer, with user information. Since the passing of information between enabled devices is achieved through the protocol of the invention, this form filling feature is one contemplated between an enabled client and a non-enabled server. Form filling would, for instance, find use in on-line transactions. E-commerce websites typically require certain address and credit card information in order to finalize a transaction. By making use of the protocol of the invention, a communication can be established between the enabled client computer and a user information source to achieve the downloading of relevant user information to the computer and thereby fill in the appropriate fields on the internet form. The user information source may, for example, be a file on the computer or a portable storage device that contains the user information in enabled form. FIG. 16 shows one embodiment of a user interface for entering this user information and for mapping each entry to one or more terms that are commonly used on internet page tables. Several folders are shown, such as the name folder 160, which is currently selected and includes various files, such as the “Last Name” file which is shown in the field 162 and the field 164 which shows the currently selected folder. The field 164 includes two sets of data entry locations: user information data entry locations 166, and commonly used names data entry locations 168, thus allowing the data in locations 168 to be mapped to the data in the locations 166. An intuitive descriptor 170 is shown alongside each data entry location. Drop down menus (not shown) are provided by performing a right mouse click, to facilitate the adding of new folders, editing functions, and to add and delete information to the field 162. Similarly the data entry locations 168 include drop down menus (not shown) for selecting from predefined commonly used names. The locations 168, in this embodiment may also be right clicked to provide a menu for selecting from options such as “Add New Field” or “Delete” in order to add additional names or delete a defined name from the drop down menu. Once the mapping has been performed, any web site that has a data entry table with words corresponding to any of the mapped words in the locations 168, can automatically be filled in by invoking an auto fill feature of the invention. This causes the mapped user information to be transferred to the corresponding data entry table fields. It will be appreciated that information can be transferred not only to a table or form, but that the protocol can be used to transfer data such as personal information from one device, e.g. a portable storage or other device, to a second device such as a user's computer for subsequent delivery to a third party. The information may be transferred transparently or may be visually presented to the user for review prior to being transferred to the third party. The auto form filling feature discussed above, finds use, for example, in filling out internet forms where the server from which the internet form is downloaded, is not an enabled machine. It will be appreciated that where both the user's machine (which in a client-server scenario, is typically the client machine) and the server machine are enabled to communicate according to the protocol of the invention, the information can be transferred seamlessly using the protocol without the need for filling in a form using the protocol and then submitting the form using existing prior art internet protocols.

Communication according to the protocol of the invention is achieved by enabling the computer to consume enabled content. In one embodiment, the enabling of the computer with machine enabling code is performed by means of software code on a portable device that also stores the user information. As described above, the use of the portable device preferably requires user verification, e.g., by requesting a password. Once this is supplied, the transfer of the relevant information to the table takes place. As described above, the invention provides the facility to ensure that the appropriate information is directed to the appropriate fields in the form that is being filled out. For instance a user's last name may be associated with rules identifying it as being relevant to a field that is entitled “Last Name” or “Sumame” or “Family Name”. As in the previous feature of the invention, the associating of certain information with certain fields in the form to be filled out is achieved, for example, through the use of shortcuts. In a typical on-line transaction, a user requests a web page using HTTP, which transmits metadata regarding the user's browser type and operating system. An HTML web page is returned to the user which presents the user with purchasable items. Once the user has made his/her selection and clicks the purchase option, he/she is typically prompted to supply credit card information and, in order to simplify future purchases, the user is asked for a user id and password. The present invention allows the credit card and user details to be filled in automatically from a source of user information such as a portable memory device, which also constitutes an aspect of the invention. Since the protocol of the invention allows the communication of enabled content, it is possible to define rules regarding the consumption of the content. Thus the user id and password could take the form of a non-intuitive sequence of numbers, letters and symbols that need not even be visible to the user but could be attached transparently to the other data and associated with the corresponding user id and password fields of the web page. As will become clearer from the description below of the portable memory device, such a filling in of forms would add another level of security since a third party could not simply type in a similar user id and password. Even if a third party had access to the portable memory device, the third party would still require to pass a user verification which could be one or more of a number of things, including a simple a password, biometric information, etc.

Another feature of the invention, flowing from the ability to communicate with a specific user, is the provision of greater security in on-line credit card transactions. This may be incorporated in a separate embodiment or be included in one of the other embodiments. This feature of the invention includes an ever changing user specific password with the credit card transaction. Instead of simply providing a credit card number that can be stolen, the user, in one embodiment, is required to also supply a password. The invention, thus expands on the notion of a password by introducing a changing password. In one embodiment, the password is changed by the credit card issuer or an entity acting on behalf of the credit card issuer, immediately after each transaction. This prevents a vendor from debiting the credit card holders account twice. The new password is sent to the credit card holder in a user specific communication for use in the next credit card transaction. In one embodiment, the password forms part of the user's personal information and is automatically stored with the other personal information such as credit card numbers. It need not even be visible to the vendor or even the credit card issuer or authorized agent. Since the user specific communication inherently ensures that it is the credit card holder that is submitting the credit card information and associated password, the vendor is protected. Similarly, the credit card holder is protected against double debiting of his or her account since the password changes, for instance immediately after conclusion of a transaction. In another embodiment, the password times out or becomes invalid after a certain period of time. Thus the user need not memorize or even be familiar with the password, since it changes automatically with each transaction and is saved with the rest of the user's personal user information. Since the user is thereby relieved of remembering his or her password, it will be appreciated that the password can be any combination of numbers, letters, and symbols. It will also be appreciated that in another embodiment, the password can be changed at regular time intervals or on occasions other than after a credit card transaction. In a typical scenario, a user would submit his/her credit card transaction and password to the vendor who would submit the credit card number, merchant code and amount to the credit card company/issuer or an authorized agent of the credit card company/issuer. Once the credit card company has debited the user's account and credited the vendor, it generates a new password which it submits to the user on-line using the internet or some other electronic network. This password then automatically is associated with the credit card number for the next transaction. Thus double billing would be avoided since a second attempt by the vendor to submit the credit card transaction to the credit card company would constitute the submission of an old password that was no longer valid.

If the vendor uses an enabled machine, the password can be transmitted transparently to the vendor. Where the vendor machine is not enabled and a request form requests a credit card number, the password could be entered instead. The vendor would then submit the password to the credit card company who would verify the password and process the credit card transaction accordingly. Thus it can be seen that the manner of implementation can vary without departing from the scope of the invention. Since the credit card security aspect of the invention makes use of the same communications protocol of the invention, it allows digital information or content to be enabled. In this case, it allows the password to be communicated as enabled content, thereby allowing rules to be attached to the password as to its viewability, etc.

It will be appreciated that the credit card transaction can involve numerous variations. Instead of the user submitting the credit card number and password to the vendor, the user could submit only a password to the vendor. In one scenario of such an embodiment, the user would identify a credit card transaction that he/she wishes to engage in, and would contact the credit card company on-line for a password for the desired amount. The card company would issue a password or token of a defined value which may or may not be vendor specific. The user would then submit the password/token to the vendor, who, in turn, would submit it to the card company. The card company would then credit the vendor with the amount of the token. Thus, in this embodiment, the user is protected against double billing by the vendor, by virtue of the fact that the token/password is for a predefined amount of money. It will be appreciated that insofar as a specific vendor is identified by the user when requesting the token, this information can be associated with the token and will prevent an unauthorized person intercepting and using the token.

Yet another feature of the invention, is the ability for users to verify on-line vendors or other Web site owners. One embodiment of the invention provides the browser with a pop-up window which lists third party verification services such as Network Solutions which allows URL authentication; Dun & Bradstreet for credit verification; the Better Business Bureau (BBB) which can verify a merchant based on a merchant number, etc. Credit card issuers such as Visa could also provide feedback on the creditworthiness of a party. Even when no information is provided one or all of these entities, it provides the user with valuable information to decide whether to transact business with such a vendor and what personal information the user is willing to disclose.

For example, in an on-line airline ticket purchase, a user may look into a travel agent's background using on-line verification, such as the one described above, and then provide the travel agent with a unique password for use in the credit card transaction. The travel agent may then invoke yet another feature of the invention, namely perform a user background check. For example, using a software program, a vendor or other entity may compare user information to a database of information, or submit the user details to the State Department or other entity to ensure that the user passenger is not on a wanted list or otherwise blacklisted. In order to gather the relevant information, the travel agent may require additional information from the user, such as a passport number, before completing the ticket purchase transaction.

As mentioned above, yet another feature of the invention is the use of a portable memory device, also referred to as a portable storage device or a portable user device, such as a storage device on a key ring to store the personal user information and to communicate this information to another device or computer. In this way a user can carry his/her user information, including passwords and, user id's, around with him/her and upload the information to any computer, which can be any intelligent machine, thereby essentially configuring the machine as his/her own machine for the duration while the user is working on the machine. The portable storage device's primary functions are to provide a portable secure storage and communication of an individual's digital information, digital licenses, user logins, passwords, and other information. The portable storage device accomplishes these tasks by providing an information storage system, and the rules based access system and protocol of the invention to enable the communication using rules and preferences on how each unique communication is to occur. The portable device provides a further level of security. No longer will hackers be able to guess a person's user id and password and steal their digital identity. As discussed above, the password may take a variety of forms, including biometric information, etc. Even if only a sequence of numbers, letters, and symbols is required, this no longer need be a simple sequence of letters or numbers that the user can remember and that could conceivably be determined by a hacker. It could be any sequence of letters, numbers and symbols that may not even be typeable on a keyboard and could be made to be dynamically changeable. The hacker will be required to have physical possession of an individual's portable memory device and substantially more user identifiable information. The invention further proposes providing the portable memory device with a device identifier which is made available during any communication with another computer or other machine. Thus, using third party authentication services, just like a credit card a user can report a portable memory device as stolen.

One type of portable user device could involve a smart card that stores all of the user's personal information, including medical information and could replace current drivers license or other identification cards. In fact, since it can store any information about the user including banking information, it could replace all current cards such as credit cards, ATM cards, medical cards, etc. In order to partially authorize certain people to gain access to predetermined portions of the information, different portions may be accessible under different passwords. In this way a doctor or hospital could gain access to the medical data through a password that is known by the doctor or a generic password for medical information, insofar as it relates to non-confidential medical information.

For ease of portability, the portable user device could be shaped substantially like a credit card to easily fit into a wallet. Instead, it could have means for attaching it to a person. For example, it could be in the form of a bracelet or necklace or ring. It could also have means such as clips for clipping it to a hand bag, backpack or article of clothing.

Not only is the communication between the portable device and the machine governed by the protocol, but subsequent communications between the machine and other devices, can also be governed by the protocol insofar as the other device is enable. Even where the other device is not enabled, the enabled user machine can communicate user specific information and downloaded information according to the rules defined on the portable device. Since the communication of the information from the portable device to the computer takes place in accordance with the protocol of the invention, the portable device preferably includes the machine enabling code to enable the machine it is to communicate with.

The portable device allows numerous rules to be defined for the communication in terms of the protocol of the invention. Since cookies to glean information from users are no longer needed, the user, in one embodiment, is given the option to specify a rule that deletes all cookies off a computer or all cookies placed on the computer after a certain time and date.

The portable device of the present invention has the advantage that it provides a lot of authenticating user information that remains in the control of the user. Thus, when the user accesses a third party website, the website owner can verify the identity of the user. While other technologies such as Microsoft's Passport, seeks to provide a user verification system, it requires the user's information to be stored at a central location over which the user has no control. The present invention also has the advantage that the user need not obtain third party authentication every time the user engages in a browser session.

The portable device provides for numerous applications where user specific information is made available to achieve certain results. One example of an application of the portable device is in configuring a controller in a motor vehicle that controls various aspects of the car such as seat adjustment, mirror positions, and pre-programmed radio channels, the portable device will interact with the controller to adjust the settings to the user's preferences. Ideally the controller will also include an interface to the ignition system to prevent the vehicle being started unless the communication between the controller and the portable device verifies that the user is an authorized user. An authorized user can be defined to simply be a user that is of driving age, or it may be more specific as to user parameters, thereby acting as an anti-theft device.

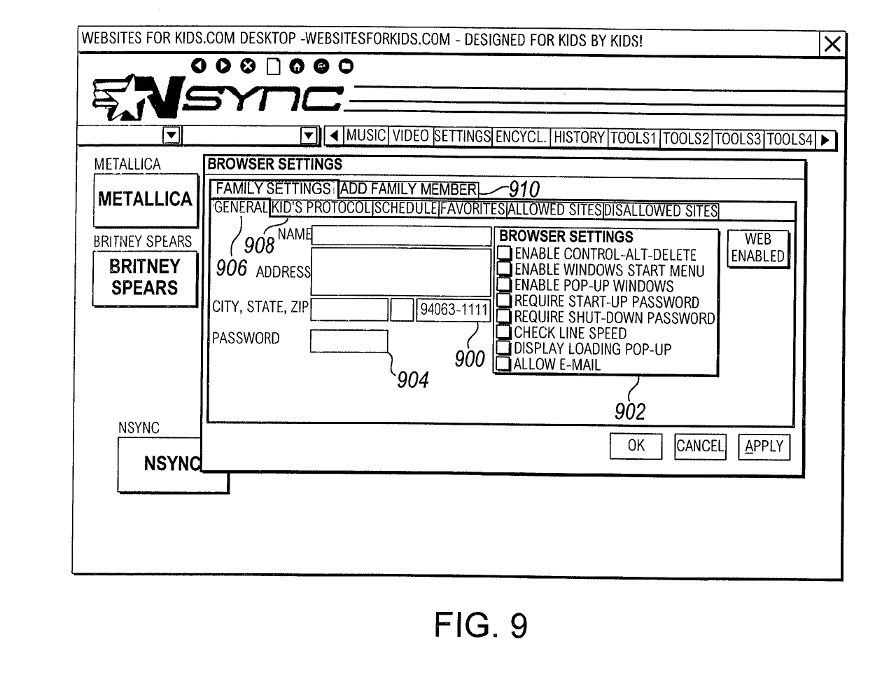

Another implementation of the portable memory device is the provision of a kids portable device in which the digital content includes metadata to define the user as a child. In this way the user agent stream that is sent to a website owner when a child seeks to access a website, is modified to inform the website owner that the user is a child. Thus website owners would be put on notice that they are dealing with a child and could not claim ignorance. Under the Children's Online Privacy Protection Act (COPPA) the gathering, use, or disclosure of child information from kids below the age of 13, requires parental consent. Once the website owner is aware of the fact that he/she is dealing with a child, the owner can seek to obtain the parent's consent by sending a request for consent message which can be stored on the kid's portable device and can be automatically linked to a metatag that invokes the website owner's website. This identifying of the user as a child occurs transparently. Similarly, insofar as the website server is enabled with the protocol of the invention, the sending of the request for consent by the website owner can also occur transparently whenever a communication from a child is detected. Current technology allows metadata to be transmitted under HTTP, in the form of a user agent stream that could identify the user as a child. However this requires a programmer to implement this in a user agent stream. The present invention, on the other hand, allows a lay person such as the child's parent or guardian to define the metadata that is made available by filling out a user information form, similar to that discussed below with respect to FIG. 9. The parent could also predefine certain websites as acceptable to the parent, and to which the parent grants consent.

The invention contemplates replacing all existing access cards with a single portable user device. Thus, the user specific information may include credit card information, debit card information, ATM card information, office access card information, club access card information, medical information, gas station card information, toll gate pass information, and internet site subscription information, to name but a few. It will be appreciated that not all the information need be included but could be added as needed by a particular user.

The uploading of information from the portable device can take place via a physical connection or a wireless connection such as bluetooth. Any changes to the personal user information, such as credit card passwords, mentioned above, are automatically downloaded to the portable device. The portable device can also include other information such as licensing information which defines the digital content, e.g. software applications, videos or music, that the user is authorized to consume. It can also include auto form filling software for transferring some or all of the user information to a form, e.g. a form on a website, thereby avoiding the need to laboriously type in the user information whenever a credit card transaction is performed on-line.

It will be appreciated that, the auto form filling software and any of the personal user information that facilitates user specific communications is unique in and of itself, and need not necessarily be provided on a portable device. It can also be permanently located on the user's personal machine, or at a central location that is accessible only upon suitable user identification.

Installation

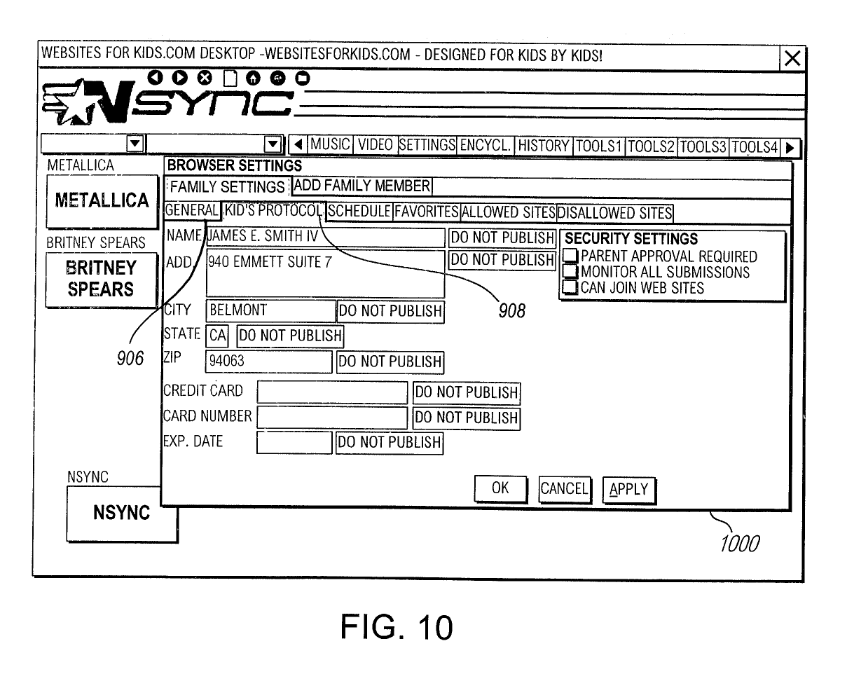

In order to initially gather the user information, the installation of the program invokes an information gathering screen. In a kids scenario, parental consent may be required, which may take the form of different levels of consent, defining what content the child may receive or disclose. As shown in FIGS. 9 and 10 parental information is gathered. FIG. 9 shows a typical data entry screen for supplying parental/guardian information in data entry locations 900, and by specifying characteristics that are to be adopted by the device by marking check boxes 902 which define enablement features. In this embodiment the enablement features include the ability not to enable the Control-Alt-Delete feature to avoid a child inadvertently rebooting the computer; not to enable the Windows Start Menu; not to enable Pop-up windows, to inhibit unwanted advertising; enable or disable the need for a Start-up and Shut-down password; enable checking of the line speed; enable or disable the display of a loading pop-up (a loading pop-up may be undesirable where sites are downloaded in rapid succession), and the ability to enable or disable e-mail. These parameters are protected by requiring a password in block 904. In another embodiment, instead of disabling advertising altogether, the user or the user's guardian may be given the option of selecting a certain type of advertising that is pertinent to the user's interests, or allowing the advertising to be dynamically adjusted based on the user's information, in the same way that other content is tailored to the user's information.

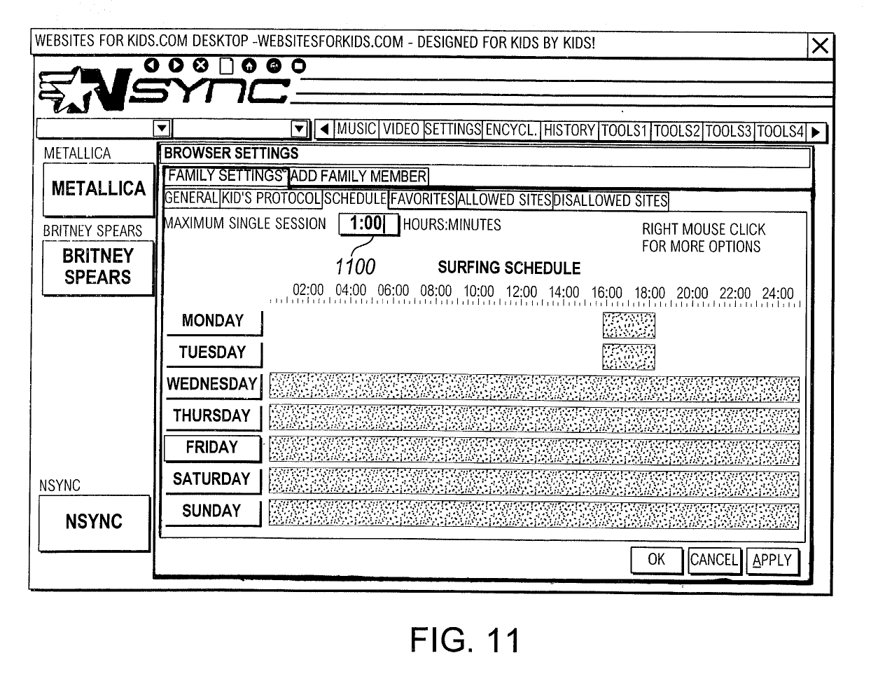

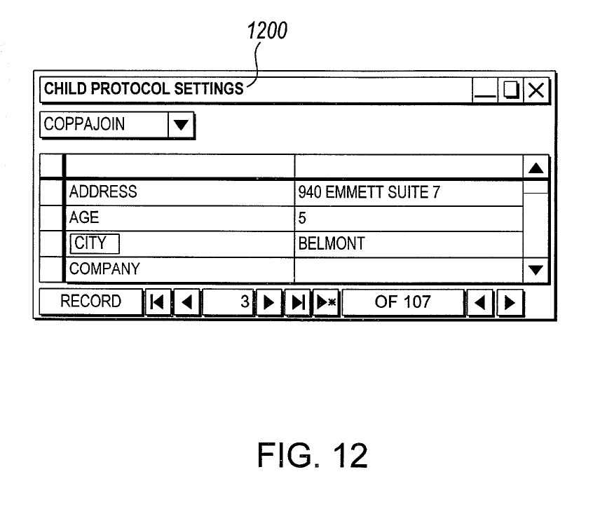

FIG. 10 shows a parental confirmation screen 1000 for entering the confirmation information such as credit card information. In this embodiment, the parent can specify what information may be published. As is clear from the tabs visible in FIGS. 9 and 10, the Family Settings option allows not only the General information tab 906 or the Kid's Protocol tab 908 to be selected, as shown in FIGS. 9 and 10, but other tabs, including a Schedule tab which brings up a scheduling screen as shown in FIG. 11 to define a weekly schedule during which a child may access the computer. The scheduling screen also allows the maximum time that a child may use the computer in a certain session, to be specified, as provided for by the data entry location 1100. FIGS. 9-11 also include tabs for specifying favorite sites (Favorites), Allowed Sites, and Disallowed Sites for a particular child, allowing a parent to override a content provider's decision. Once the parent has customized the computer for the child user and verified his/her own identity, family members may be added using the Add Family Member tag which brings up a screen for selecting a type of family member, e.g., adult, teenager, or child. Each such selection allows user specifics to be entered as shown in FIG. 12. The drop-down menu 1200 allows various aspects to be addressed, such as COPPAJoin information (as shown). COPPAJoin brings up a window that includes both information entry locations for demographic data as well as some user preference information. The drop-down menu 1200 also includes other aspects, e.g., other user preferences, additional user demographics, user interests, user specified machine characteristics, etc.

Typically user information that is used for the user specific communications, may include user demographics such as the user's age, sex, language, and cultural background. In this embodiment, user interest information and user preference information are supplied on separate screens. For example, the user is prompted to elaborate on his/her interests in sports, music, outdoor activities and other interests, thereby defining the user's interest information. It also allows the user to specify preferences regarding type of content, e.g., text only, still images, sound, or video.

As discussed above, as part of the initial set-up procedure, the user or a person acting for the user, such as a parent or guardian of a child, is presented with the choice of activating of deactivating all advertising appearing on the child's screen. Another embodiment could provide the option for the user or the person acting for the user to select alternative advertising which will ensure that the advertising appearing on the user's screen is appropriate or relevant to the user.

As is discussed in greater detail below, the present embodiment allows the user to select between the available screens to add, update or edit information. In the present embodiment, in which the contemplated user is a child, the information gathering screen comprises two separate screens: one for defining, among other things, user demographics (FIG. 12), and one for specifying user interests (not shown). The former screen, in this embodiment, can be accessed only with the necessary parental authorization and can be implemented in different ways, to require any one of a number of known identity verifying or checking facilities such as credit card information (screen 1000) or signature verification. Signature verification may take place through the use of conventional mail or using electronic transmission and character recognition technology. As technology continues to develop, other forms of verification may become viable such as thumb scan or retinal scan confirmation. This verification of identity is in addition to the user information that is used to facilitated user specific communication. The verification information serves as a security feature to avoid identities being stolen. For example, where user information is stored on a portable device, as discussed above, loss of the device would allow someone else to assume the identity of the portable device owner, were it not for a user verification feature.

In response to the information gathered from the user, the server will then respond to user requests for content in a fashion that will take into account the user's demographics, interests, and preferences. Thus, in order to enhance the user experience, the invention envisages molding not only the types of content but also the manner in which they are presented, to the user's specific needs based on one or more of the user's demographic, preference, and interest information. For example, in the case of a three year old child, the sites made available to the child will be quite different to those for a ten year old, or eighteen year old. Also, the manner in which the content is presented will differ. In the case of the three year old who, in all probability, cannot read, content will be presented in the form of images, graphics, video or sound files. Thus the protocol implemented by the enabled devices will serve to adjust the look and feel of the browsing screen, and will, for example, change the background of the screen to make it more suitable to the age, sex, and cultural background of the child.

As mentioned above, the decision as to what content is suitable and should be made available to the particular user will depend on the user information that was supplied. The age, sex, and geographic location of the user are used as part of this decision making process. Thus, for example, the list of sites that are made available to the user may vary depending on the user's age. Similarly, language preference information may be used to list the sites in order of language. Thus, a user who indicates Spanish as a preference may be provided with Spanish sites listed first. Similarly, in the case of a teenager who has indicated an interest in football, NFL related sites and profiles on football players may be identified in the most prominent group of available sites. This embodiment of the invention also includes a facility for providing the user with rating information on the various sites that are available. The service provider may provide this information based on feedback from users. The ratings can also be based on the number of hits or downloads a site experiences.

In a preferred embodiment, not only user information is considered in presenting information, but also client machine capabilities and the nature of the network connection. Thus, as part of the decision making process of which sites to make available to the user and the manner in which the information is to be presented, a preferred embodiment will also consider the hardware capabilities, such as graphics card and sound card availability and parameters of the card, as well as the software available on the client machine. For example, demographic information may indicate that the user is a child below reading age. In such a case text may be replaced by sound files, but only insofar as the client machine has been determined to have a sound card and speakers. Similarly, images and even video clips may be included, provided that the client machine has a graphics card and the bandwidth that is available makes this a practical option. Thus a user with a fast Internet connection such as cable or DSL may be presented with more data intensive content like video, while another user, with a slow dial-up connection, will be presented with a less data intensive solution such as text. The bandwidth of the network connection can be determined in any known way such as the approach adopted by Bandwidth.com in which the server polls the data transfer rate over the network 14 to the client machine 12 by sending a known length portion of data and measuring the download time.

In one embodiment, the user may be presented with a choice in the form of an options list from which to select a data format, insofar as the server identifies the availability of different forms of data. Thus the user may decide to wait for video content to be downloaded even where his/her machine has a slow dial-up connection. Similarly, a user may decide to opt for quick downloads by foregoing some of the data rich content. Thus, a user can set the range of machine/device levels or characteristics. The user in this embodiment controls all delivery settings. For example, the user could specify, no sound, even if a sound card was present.

The invention thus provides a facility for two devices to exchange data and allow the device supplying the digital content to adjust the content and manner of presentation depending on the data received from the other device. Similarly the user at the other device can decide what data he/she is willing to provide to the device supplying the content. Thus, both the user or consumer of the content, and the supplier of the content remain in control over what data/content is transmitted to the other. A user may be willing to supply certain data to one content supplier, but not to another. It will be appreciated that, although the above scenario speaks of two devices, more than two physical devices or machines may be involved. For example, the content may be stored at a various sources.

The enabling code may also include additional user interactive features including providing the user with a commentary screen to allow the user to provide feedback. The feedback may be categorized. For example it can include feedback regarding potential new users, and identifying new web sites which the user would like to see included in the list of approved sites. An example of such commentary feedback was shown in FIG. 4 for feedback on movies. New sites may, thus, be added to the list of supported sites, based on recommendations submitted by users. In a preferred embodiment, a base screen or home page is provided which allows the user to select between the various screens. In the present embodiment, the browsing screen shown of FIG. 2, also serves as the base screen or home page. In this embodiment, the user may select the commentary screen from the base screen by clicking on the “Give us your feedback” link 224 in order to provide feedback about new sites, or, in another embodiment, the base screen may include a “new site” tag, for bringing up a commentary screen directly. Similarly, users may submit details of new members, for example, by using a “new member” tag. It will be appreciated that “new site” and “new member” tags could, instead, bring up separate screens specifically designed for entry of new Web site addresses for proposed inclusion in the list of supported sites, and for entry of new members, respectively. It is envisaged that, as an incentive to submit new sites and members, prizes can be awarded to users on a merit basis. Winners are preferably named in a winners list which, in the embodiment of FIG. 2 is accessed through the Contest tag 240 or, in another embodiment, a separate members of the week tag (not shown). It will be appreciated that, in the case of an arrangement directed at children, new proposed members will typically also be children. The invention, further, serves as a vehicle to induce content suppliers to register as authorized content suppliers, since it assures exposure to a defined audience, and thus provides for targeted advertising. For this reason adult authorization has to be obtained as part of the process when a user submits new member information.

It will be appreciated that the server machine 10 and network 14 are shown by way of example only and need not be a single server machine or a single network wire. The invention could be implemented on numerous server machines, and the network 14 may consist of many pathways and connections, as in the case of the Internet. Also, while particular applications were discussed above, the invention is broad enough to cover many other applications.

The present invention, for instance, provides a solution to the problem faced by the music industry, of preventing unauthorized copying and distribution of copyrighted music. It also provides a vehicle to enhancing the user experience. For example, the present invention contemplates not only structuring requested content to the user's needs but also enhancing the user's experience by causing the user's machine to perform certain tasks in response to instructions incorporated in the enabled content. In one implementation, a music CD can be implemented as a hybrid CD with audio content in the form of WAV files, which may be played on a dumb device, such as a boombox, and additional content in the form of enabled content that can be played only on an enabled machine. The enabled content may include music files or pointers to music files. It may also include other content such as a video clip or instructions to download a web site. Typically therefore, the outer tracks of the CD will support the music content. Furthermore, the CD will include tracks supporting enabling code. The enabling code performs the function of enabling an intelligent device, and of associating enabling code with all or part of the content. Thus, in the case of an intelligent device, the enabled content will only be playable once the device is itself enabled. The task of enabling the intelligent device, such as a PC, involves providing the intelligent device with an implementation of a communication protocol that allows the device to communicate with the enabling code on the CD to play the enabled content on the CD according to certain rules inherent in the enabling code. The content on the CD, which is accessible by the enabled device, may include not only the audio content that is available to a dumb device, like a regular CD player, but other content, such as video content. Furthermore, the rules inherent in the enabling code may cause the intelligent device to perform additional tasks, such as access a specific web site over the Internet that complements the video content. The web site may for instance provide information about the artist in the video or about upcoming music events in the user's geographic area.

Thus the invention also contemplates rules for pushing additional content to the user's machine, and provides a marketing tool to the CD supplier or to the content supplier. Again, however, the basis for pushing information onto the user's site may be made dependent on feedback provided by the user. For example, in one embodiment, where the CD is to be made available only to certain age groups, it is envisaged that when the CD is installed, one of the rules inherent in the enabling code will require user identification. Thus, again both parties are involved in deciding what information is made available and the form of the content.

It will be appreciated that either one or both of the code and content could be provided to a user's machine over a network and need not be provided on a CD.

As mentioned above, yet another application contemplated by the invention involves the ability of a user to carry his/her user preferences around on a portable device such as a keyring device or smart card. This will allow a user to download his/her preferences to one or more types of intelligent devices to tailor electronic surroundings to the user's needs. For example, controllers can be provided in rental vehicles which will interface with user devices, thereby to allow users to automatically adjust seat, window, and radio channels to the users respective preferences. These controllers ideally also verify user identity and disable the car unless the user is correctly identified. Thus, the controller could, for example, verify various aspects of user information, e.g., credit card number, date of birth, address, social security number, etc., provided by the portable device. Once the identity is verified, the controller will allow the car to be started. The verification could, for instance take place through a communication between the controller and the car rental agency's central computer, using a wireless modem or other connection. Instead, the user's portable device could be provided with the leasing confirmation information, e.g. by downloading this information from the car rental agency's central computer at the time of the lease, and thereafter the controller in the car simply uploads this confirmation information. As mentioned above, in order to avoid identity theft through the theft of portable devices, a password is preferably required by the portable device to verify the user's identity before the portable device will communicated with any computer or controller. The password may either serve to control the enablement of the computer or controller with machine enabling software, or may control the subsequent communications, once enabled.

In another application of the portable device, a user may carry around his/her personal preference settings for a PC. Thus, a user sitting at a computer may use the portable device to connect to the transport layer and specify user preferences in order to provide his/her personalized desktop. In yet another application, a user may use a portable device to set the lighting, temperature, music, TV, and radio channels in a room. Downloading of the information from the portable device can be by way of a physical or wireless, e.g., Bluetooth, connection. Thus dissimilar enabled devices are able to communicate device/content parameters and/or user preferences to tailor content and environments accordingly. For example, a user may prefer delivery of content in the form of sound as opposed to text. Similarly, a device may not have a sound card, thereby resulting in content being delivered in a form other than sound. Also, the content provider may specify that content may only be played on a particular device.

Implementation and Internal Structure

In order to implement the present invention, two devices or a device and the content have to be enabled. For instance, in the case of a portable device containing user identifying information, the portable device may communicate with a machine that is already enabled, or may provide machine enabling code to enable a machine that is not yet enabled. In the case of communication between a CD or floppy disk or ZIP disk, and a computer, the CD, floppy disk or ZIP disk can be considered a device or merely content, wherein the CD, floppy disk, or ZIP disk serves simply as the storage medium.

Machine enablement may be achieved in any one of a number of ways. For example, an intelligent device such as a PC may be provided with enabling code that is supplied to it on a disk or over a network. Instead the PC may be shipped with the enabling code pre-installed.

In the case of a dumb device, such as a boombox, CD player or USB hub, a translator could be provided for facilitating communication according to the protocol of the invention and thus allow the dumb device to behave as an enabled device. For example, in the case of a CD player, a device may be provided that connects to the CD player to translate the enabled content. In the case where the dumb device has internal memory that can be read, the translator may simply be a software layer that is accessed to perform the translation.

In the case of the client-server arrangement of FIG. 1, the client machine 12 has to be enabled to communicate with an enabled server 10. The client 12 is enabled by providing it with enabling code, which, in this embodiment, is supplied to the user on a CD or over the network 14, and stored in the storage 26. The enabling code allows the client 12 to communicate according to a specific communication protocol and associates a particular user to a communication session. The content or machine supplying the content is also enabled to permit communication between the client and the content or machine supplying the content, according to the protocol. By defining rules for the exchange of information and/or content, the protocol places the two communicating parties in control of what content is made available and in what format. As discussed above, in the case of a minor, some of the decision making is determined by the parent or guardian, but, nevertheless, the communication is then unique to the particular user as opposed to being generic to the client machine. The rules may differ from one application to the next. For example, in the child protection scenario discussed above, the enabling of the client provides for the request for user information. The supply of such information is determined by the user as the user sees fit, and the resultant presentation of available Web sites to the user is based on the information supplied by the user.

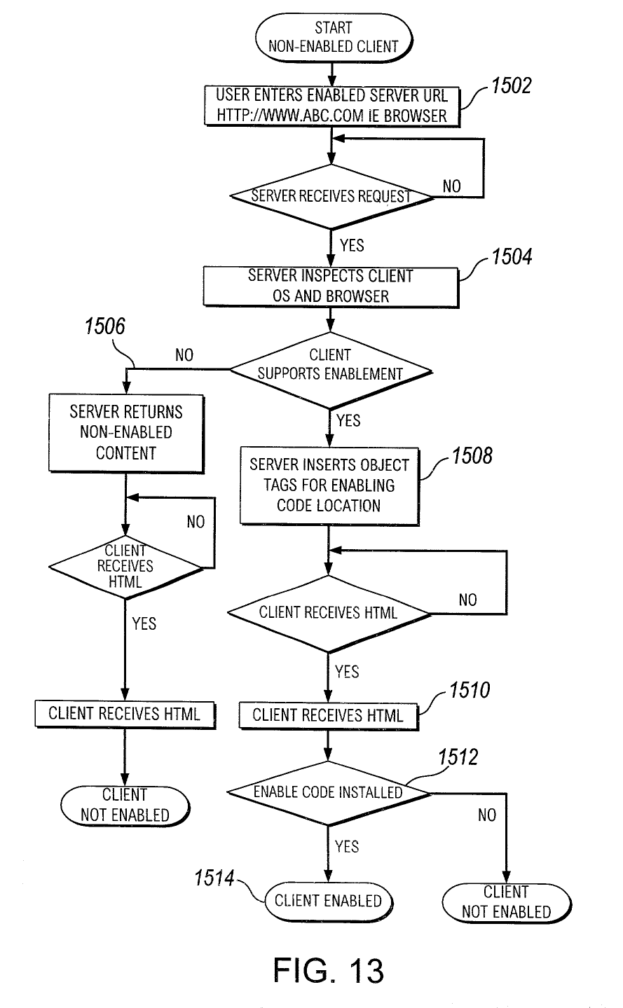

The functional steps involved in enabling a client are shown in FIG. 13. After entering the URL of a web site for an enabled device such as an enabled server or enabled client (step 1502) the protocol inspects the user's machine operating system and browser (step 1504) to determine whether the client supports enablement. If not, non-enabled content will be delivered (branch 1506) using any available communication protocol such as HTTP. If the client supports enablement, the enabling of the client proceeds. The server inserts object tags for the location of the enabling code (step 1508). Thereafter the client receives HTML (step 1510) and if the enabling code is installed (step 1512), the client is enabled (step 1514). The installation program sets certain parameters or signatures on the client computer, which will thereafter be recognized to avoid subsequent reinstallation of the installation program. In some situations a single client enablement may support numerous subsequent communications. In other applications, such as the music industry, where different CD's are to be individually uniquely protected, each different CD will include its own unique enabling code. The signatures set by the installation program are typically stored in one or more of the hard drive of the computer, the registries in the case of a windows computer, and windows system files. The installation program stores executable software (which can be defined as the enabling code) and certain files in these locations. The files may, for instance, include a file name and a version number to identify the existence of enabling code and allow the current version to be checked and updated if necessary. Once enabled, the newly enabled machine (in this case the client machine) will communicate with the server according to the protocol of the invention. Thus, any request for content will be received by the content supplier (in this case the server) and processed according to the protocol. User information will be requested, or if previously supplied as part of the enabling process, will be used to determine what content to make available and in what format. The invention thus also defines a unique file format in which content or pointers to content are stored in conjunction with rules for consuming the content. This file format is only accessible through the use of the protocol of the invention which is embodied in the rules of the enabling code and imparted to a device or machine through the device enabling steps discussed in more detail below. Broadly viewed, the steps involved in enabling a device for a child user and providing targeted content can be summarized by the following steps:

determining whether a machine is enabled, and, if not, determining whether it is capable of being enabled, and, if so, providing enabling code to the machine,

generating an information gathering screen for a browser user interface to allow the user or the user's guardian to enter user demographic information (as illustrated in FIG. 12),

transmitting this information to the server 10 or any other defined location,

generating an information gathering screen to allow a user to provide user preference or user interest information,

transmitting this information to the server 10 or any other defined location,

generating a browsing screen to allow the user to brows a predefined set of web sites.

These steps may comprise separate steps of lumped together in a single communication. For instance, the information gathering may form part of the enablement of the machine. Thus, providing the enabling code to a client machine may include requests for certain user information, thereby providing a server driven process. Instead, the client may be enabled, whereafter, a request for certain content will invoke a request for user information. Thus, the user information gathering process may be associated with the content itself. Furthermore, the communication of user information need not be between one machine and another, but could be a communication taking place on one machine based on communications with enabled content with its inherent rules for consumption. Thus the protocol provides for multiple requests and single or compound commands. Information can be requested all at once, in groups, or can be requested individually. Responses may also flow in groups or individually. Either side may terminate the communication at will.

It will be noted that the parent's or guardian's assistance was invoked and that the gathering of the demographic details required parental consent. This is necessitated by certain legal provisions such as the Children's Online Privacy Protection Act (COPPA) which restricts the gathering of child information for kids below the age of 13, by requiring parental consent.

In this application the enabling code includes a browser or code to be used in conjunction with an existing browser to ensure that the user interface of the browser, does not include a web address entry location. This was discussed in detail above with reference to FIG. 2. Once the user information is gathered, it is stored on the client or the server or any other location, and is associated with a user identifier such as a password or thumb scan verification. Thereafter, whenever the user logs on as the authorized user, the rendering code, which could be stored on a server, presents a browsing screen, geared to the user's profile. It also invokes the user information in making content available. Thus, only web sites appropriate for the user are made available based on a protocol that exchanges the various parameters and determines what content to make available and in what form

Thus, inherent in the process of enabling the client machine is the provision of the means for communicating between two devices according to a defined protocol and the association of a particular user with a communication scenario. The association with a particular user involves extracting user information from the user and providing for a password or other form of user identification. Once user information has been gathered from the user, digital content is presented to the user based on whatever user information the user chooses to supply. However, until the user's identity is sufficiently known, the protocol will define the user as a child. Thus, while one feature of the protocol is to allow the user's age to be specified, the default in this embodiment, is a child of age 3.

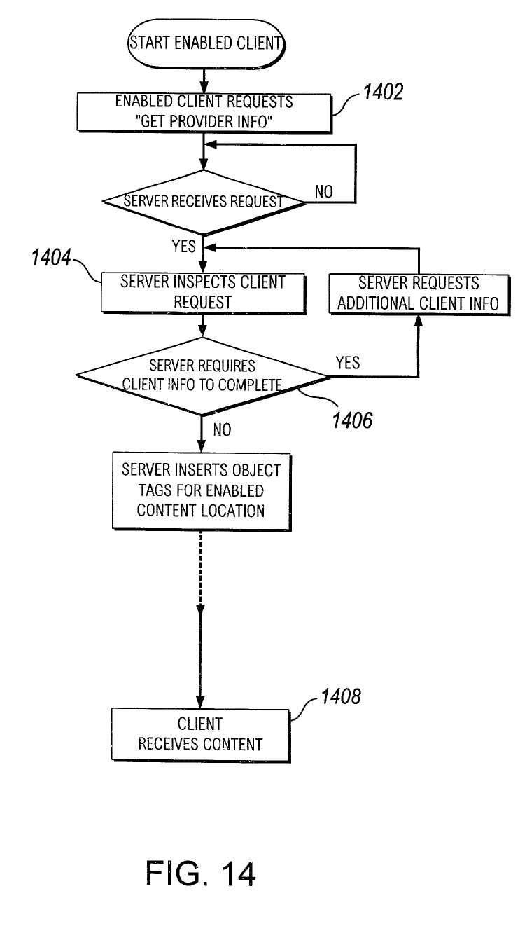

FIG. 14 shows the negotiation steps between two enabled devices. In step 1402 the enabled client requests information from an information provider by clicking on a hypertag of an available site. Once a server receives a request for content, it inspects the request (step 1404) and determines whether it requires additional information (step 1406) from the client, e.g., credit card information, before supplying the enabled content (step 1408). In the case where the client requests a web page/content, the client may only request the location of the content and provide no user information. Alternatively, the client may specify, in the original request, the user information, thus potentially avoiding further requests for information by the server machine. Thus, in one embodiment, the server can provide the requested content, or, in another embodiment, it can request additional information from the client. If the client responds to the request, this, in and of itself, would indicated enablement of the client. Similarly, the request by the server to the client would demonstrate to the client that the server is enabled. In either case, the server would identify the client as having been enabled.

It will be appreciated that various applications of the invention may provide for different approaches in enabling a machine. For example, in the scenario where children are to be protected from undesirable content on the Internet, the user's device can be enabled in any one of a number of ways. For example, it can be installed on the user's machine by means of a compact disk or floppy disk. It can also be downloaded from a server or any other device over a network such as the Internet, or a wireless connection, e.g. a radio communication link, infra red link, blue tooth connection, etc. One commonly known approach for implementing software over a network is by way of an Active X component or Java Applet.

While the term client and server M ere used in the embodiment of FIG. 1, the invention envisions many other scenarios including peer-to-peer communications. Thus any two clients could initiate communications with each other and exchange digital content files.

In order to appreciate the broad scope of the invention, it helps to consider a different implementation of the invention. For example, in the music industry scenario the two devices may comprise a PC and a compact disc. The compact disc serves as the vehicle for the content and for providing enabling code to the PC. Thus the disc, which in this example is a hybrid CD, includes content, code for enabling the PC, and code for enabling some or all of the content by associating rules with the content that will define how and under what circumstances the content can be played. The installation script will determine whether the PC is enabled for the particular CD. If not, it may play part (i.e., a preview) or none of the content. The enabled content may thus include a preview portion that can be consumed on a non-enabled machine. In a preferred embodiment, the enabled content will also include executable code for enabling the client machine. Once enabled, the user will be prompted for information in order to consume the enabled content. Typically, the user will be asked for billing information. Once this information is provided, the rules allow the content to be consumed and, as discussed above, may cause the PC to perform additional functions such as download a related Web site. As discussed above, the enablement of a client can be identified by means of certain signatures set by the installation program. Thus, the content is associated with a particular user, thereby avoiding the unauthorized distribution of the content. In this situation, the license is for the specific user. Thus only the licensed user would be able to consume the content, e.g., play the music. In one application, a music service could be provided that delivers music that was purchased by a user, thereby allowing the user to listen to the music at his/her home, at a friend's house, in the user's office or car, or anywhere else that the user identifies him/herself. Any transfer of the content to another device, for example, over the Internet, preferably causes the enabling code to be transmitted along with the content. Any attempt at playing the content on another intelligent machine will thus limit the playing according to the content provider's rules. For example, the content provider may provide that 10 seconds of the content can be played whereafter the user is prompted for credit card information to purchase rights to the use of the rest of the song or video. Thus, in this example, the user is given the opportunity to sample the content or play it a limited number of times before being requested to purchase permanent rights to the use of the content. If the new user chooses not to avail him or herself of the offer, further access will simply be denied to the new user. In this way the invention contemplates controlling the unauthorized copying and distribution of digital content such as music or videos. In both the child protection and music industry scenarios considered above, the communication process invoked by the enabling code, defines what content is to be made available and how it is to be made available. In a preferred embodiment, billing information or other information, once provided by a user, may be retained at some central location, e.g. on the user's machine or a server, to allow the user simply to confirm billings for future transactions without having to reenter the information each time. In one embodiment, the user information may be retained on a portable identification device (PID). In a typical scenario, the user identifies him/herself to the PID. When the user connects to the content provider such as Sony Music, using the PID protocol, the user is prompted to purchases a license, covering one or more songs or albums, confirmation of which is stored on the PID. Thereafter, when the user requests content, the PID is checked to confirm the license status, and content is provided to the licensee subject to a paid up license, allowing the user to consume the content. It will be appreciated that the connection to the content provider may be by way of a request for content, which prompts the checking of the PID for a paid up license. Insofar as no paid up license is identified, the user is first prompted to supply the necessary billing information, whereafter the content is provided. In another scenario, the PID may include the user's medical information, e.g., updated innoculation information, or pointers to the location of the information. Since the content on the PID is enabled content, and is thus associated with rules for consuming or applying the content, the user may include rules defining what device the PID can interface with. Thus, a particular device identifier can be associated with the content to restrict copying or define what can be copied to other devices.

It will be appreciated that, since the rules associated with the enabled content are transferred with the content whenever a transfer of the content takes place, peer to peer communications can take place without compromising the security of the content. Unauthorized consumption will still be prevented since any attempt at playing the content will invoke the associated rules. Thus, whether the content is streamed to a new user's player or downloaded to the user's hard drive, the rules for playing the content will be invoked. Only a licensed user can play the entire content. It is conceivable that an enabled user, once he or she has access to the entire content, could play the content from one sound card to another and thereby make an illegal copy. The present invention seeks to limit such activity by including a personal identity or unique digital signature in the content, such as a high frequency signal or some other signal that does not interfere with the enjoyment of the content but nevertheless inserts the user's unique digital signature in the unauthorized copy. Since this digital signature will attach to all subsequent copies, it will allow the user easily to be identified.

The present invention preferably incorporates compression and encryption schemes to further deter would-be offenders. In one embodiment, the content with its rules envelope can, optionally, be compressed. Each item, for example, each song, within the envelope can be individually encrypted to further stymie attempts at circumventing the protection. Similarly, the header information that controls the reading of the files on the CD, may be encrypted.

It will be appreciated that, while the enabling code for enabling the user machine was loaded onto the intelligent machine in each of the examples considered above, it could equally well be retained on one or more servers or other devices, e.g. other computers, smart cards, disks on keyrings, etc., and the code instructions invoked as needed. From the discussion of the implementations, it will also be appreciated that the rules for rendering content, which take the form of rendering code instructions, are not limited to the rules discussed above. The enabling code can include any rules relating not only to the content itself but also to other activities of the client machine, such as the acquisition of information from other sources.

The implementations discussed so far, have dealt with user machines in the form of computers, typically connected to a server. However, the invention need not necessarily involve a PC. As mentioned above, the invention also envisages an implementation in which a small portable intelligent device is enabled, such as a smart card or key ring device which includes enabling code in the form of a magnetic strip or chip. In one implementation, the device includes personalized information of the user. For example, it may include preferential settings for the user's motor vehicle seat and mirror positions, or preferences for the user's PC user interface arrangement, or preferential lighting and music settings for a hotel room. Thus by downloading the information on the device to a controller that controls the particular environment, the user can enable the controller to communicate with the portable device. In this way the user can instantaneously adapt any environment to his or her preferences. In one implementation, Bluetooth provides the transport for the protocol.

Numerous other applications of the invention can be envisioned. For example the digital content may comprise a childrens' book or story wherein the enabling code includes rules for requesting user information such as the child's name, pet's name, friends' names, etc. This information could then be included in the story line, in place of the generic names that would be found the presentation of the non enabled version. In this way the child can be the hero in the story and be more of an active participant. It will be appreciated that this would provide for precise tailoring of the digital content. Entire movies, books, advertisements, etc., could use names, identities, and related specifications familiar to the user. For example, a dog's name in a movie or book could be the user's dog, or a name specified by the user or the user's parent or guardian. Likewise, a user's favorite car, song, color, etc., could be dynamically integrated with the content, thus delivering unique content for each user.

It will be appreciated that the above embodiments are given by way of example only, and that the invention can have numerous applications and be implemented in various ways without departing from the gist and nature of the invention. A device can be enabled in any one of a number of ways, and is not limited to the examples given. Similarly the nature of the rules defined by the enabling code, is not limited to the examples given, nor is the invention limited to the particular applications described.

What is claimed is:

1. Means for supplying user information from a user information source to a form or table on a computer, having user information fields, comprising
code for enabling the computer to consume enabled content, wherein the user information is in the form of enabled content, and
code for transferring at least some of the user information from the user information source to the form or table.

2. Means of claim 1, wherein the user information source is a portable device and includes the code for enabling the computer.

3. Means of claim 1, wherein the computer is a machine capable of browsing the internet.

4. Means of claim 1, wherein the user information source includes a user interface that defines a template with fields for receiving user information and wherein at least some of the user information corresponds to at least some of the user information fields in the form.

5. Means of claim 1, further comprising code for requesting and verifying a password.

6. Means of claim 5, further comprising code for associating a descriptor with one or more internet addresses.

7. Means of claim 6, wherein the descriptor is a word, phrase, or other assembly of one or more of numbers, letters, and symbols.

8. A method of supplying user information to a form or table having user information fields, comprising
gathering at least part of the information required by the fields,
storing said gathered information in a local or portable storage device, and
extracting said gathered information from the storage device and inserting it into the form or table.

9. The method of claim 8, wherein the information in the storage device is used to fill out any form that requires some or all of the stored information.

10. The method of claim 9, wherein the form is a form or table on an internet site.

11. A method of simplifying internet browsing, comprising
providing software code for associating a descriptor with one or more internet addresses, and
providing software code for accessing an internet site or a choice of internet sites in response to entry of a descriptor.

12. A method of claim 11, wherein the descriptor is entered by typing it into an internet address field of a browser interface.

13. A method of claim 76, wherein the descriptor is a word, phrase, or other assembly of one or more of numbers, letters, and symbols.

14. A method of simplifying access to internet sites, comprising
providing a browser interface that eliminates the need to type in web addresses by providing a facility to configure the browser to associate one or more internet sites with a predefined identifier.

15. A method of claim 14, wherein a user accesses sites by typing in predefined identifiers or by selecting form one or more lists of available sites.

16. A method of claim 25, wherein the identifiers are words or phrases or any other combination of letters and numbers.

17. A portable user device, comprising
a memory,
user specific information stored on the memory, and
software code for facilitating the transfer of at least part of the user specific information to a third party request form on a computer.

18. A device of claim 17, wherein the user specific information includes information required for credit card transactions.

19. A device of claim 17, wherein the memory includes computer enabling code for enabling the computer to consume enabled information, wherein the user specific information is provided as enabled information.

20. A device of claim 17, wherein the memory includes code for requesting user verification information.

21. A device of claim 17, wherein the third party request form is part of an on-line transaction form.

22. A device of claim 17, further comprising software code that associates at least one internet address with a predefined descriptor, such as a word, phrase, or other assembly of one or more numbers, letters, and symbols.

23. A device of claim 22, wherein the associating code interacts with network browser software to download an internet page or provide a choice of internet pages associated with the descriptor, when the descriptor is selected or typed in on a user interface associated with the browser.

24. A device of claim 20, wherein the user specific information includes medical information about the user.

25. A device of claim 24, wherein the user specific information includes consent information to perform one or more medical procedures.

26. A device of claim 20, wherein the user verification information includes a plurality of passwords, each of which facilitates access to one or more predefined portions of the user specific information.

27. A device of claim 26, wherein at least one of the passwords is of a generic nature that is commonly known to facilitate access to the corresponding one or more portions by anyone entering the password.

28. A device of claim 17, wherein the user specific information includes at least one of credit card information, debit card information, ATM card information, office access card information, club access card information, medical information, gas station card information, toll gate pass information, and internet site subscription information.

29. A device of claim 28, wherein the device is shaped substantially like a credit card, or has means for securing the device to a person or to belongings commonly carried by people.

30. A portable user device comprising
software code that associates at least one internet address with each of a plurality of predefined descriptors, and
software code for interacting with network browser software to download an internet page or provide a choice of internet pages associated with a descriptor, when said descriptor is selected or typed in on a user interface associated with the browser.

31. A portable user device of claim 24, wherein the descriptor is a word, phrase, or other assembly of one or more of numbers, letters, and symbols.

32. A method of providing greater security to a credit card transaction, comprising
associating a user identifier with a user's credit card number, wherein the user identifier dynamically changes at defined intervals or occasions.

33. A method of performing a credit card transaction between a credit card holder and a seller, comprising,
submitting a confirmation code to the seller, wherein the confirmation code is changed automatically at defined intervals or defined occasions.

34. A method of claim 33, wherein the confirmation code is changed automatically before or after each transaction.

35. A method of claim 33, wherein the confirmation code is generated by the credit card issuer or an authorized third party acting on behalf of the credit card issuer.

36. A method of claim 33, wherein the confirmation codes are sent to the credit card holder electronically over an electronic network.

37. A method of claim 35, wherein the confirmation code is submitted to the seller over an electronic network, and wherein the credit card issuer or authorized third party processes the credit card transaction and generates a new confirmation code which is sent to the credit card holder over the network.

38. A method of claim 35, wherein the confirmation code is linked to user identifying information, and stored in memory that is accessible to the credit card issuer or authorized third party.

39. A method of claim 33, wherein the confirmation code has a predetermined valid life span.

40. A method of checking a party's identity in a transaction, comprising
requesting user information from the party, and
submitting the user information to a third party or software program.

41. A method of claim 40, wherein the software program compares the user information to a database of information and identifies problems.

42. A method of claim 40, wherein the transaction is a request for a plane ticket or a ticket to an event.

43. A method of claim 41, further comprising notifying one or more predefined third parties in the event of a problem being identified.

44. A method of claim 40, wherein the user information is requested as part of an online transaction.

45. Means for supplying user information from a first device to a second device by means of a communications protocol, comprising
code for enabling the first device to consume enabled content according to the protocol, wherein the user information is in the form of enabled content, and
code for transferring at least some of the user information to the second device.

46. Means of claim 45, wherein the first device is a portable device.

47. Means of claim 45, wherein the computer is a machine capable of browsing the internet.

48. Means of claim 45, wherein the first device includes a user interface that defines a template with fields for receiving user information and wherein at least some of the user information in the template corresponds to at least some of the supplied user information.
